(19) United States
(12) Patent Application Publication
(10) Pub. No.: US 2004/0073871 A1
(43) Pub. Date: Apr. 15, 2004

(54) Method and system for authoring content

(75) Inventor: Fabio Giannetti, Bristol (GB)

Correspondence Address: HEWLETT-PACKARD COMPANY, Intellectual Property Administration, P.O. Box 272400, Fort Collins, CO, 80527-2400, US

(73) Assignee: Hewlett-Packard Development Company, L.P.

(21) Appl. No.: 10/656,776

(22) Filed: Sep. 4, 2003

(30) Foreign Application Priority Data
Sep. 5, 2002 (GB) 0220710.8

(51) Int. Cl. G06F 17/00

(52) U.S. Cl. 715/513

(57) ABSTRACT

Content to be served is authored by authoring a layout document which defines at least one area of a document which includes the content to be published and authoring at least one binding element which defines the identity and location of at least a portion of content and at least one style description which defines a style to be applied to a selected portion of content. Authoring of the layout document includes allocating to the at least one defined area a director to at least one binding document of the or each binding element such that when processed the published document includes in the defined area the content as directed by the binding element in the style as directed by the binding element. An appropriately programmed computer can generate such servable content, which can be served by, for example, a web server.

This invention relates to a method of authoring content, especially content to be processed by a web server. It also relates to a system for authoring such content.

The delivery of information to computing devices remote from a server is well known and is becoming more prevalent with the increase in popularity of the internet and the world wide web. Presently, there is a growing trend to access data from a variety of different devices. For example WAP enabled telephones, web enabled television sets, computers such as PCs, PDAs and the like are all being used to access information across networks. It will be appreciated that such a diversity of devices with different capabilities for handling and displaying data presents interesting challenges for the author of documents that are to be processed by a web server or browser in order to tailor the document to each device. It is therefore becoming more important that the author is provided with the tools required to author web content in a flexible, and easily revised manner.

There is also a drive to simplify the authoring process in that there is a continuous need in many cases to revise the authored content to alter its appearance or actual content over time. For example, a colour scheme or layout for a corporate web site may need to be changed if the company has a change of branding. Alternatively, it may be desirable to make regular changes to reflect the changing nature of the content of the web pages. For example, a web page publishing details of the weather may require a daily update of its content. A web page that is out of date or contains obsolete information gives a poor impression to a client of the owner of the site.

At the time of writing, the standard tools for use by an author in generating, or “authoring” web content such as a document defining a web page, provide the author with a way to create a layout document and place some content within the layout with some style applied to it. An example of a simple web page document 200 is shown in FIG. 2 of the accompanying drawings. The layout document 200 defines four discrete areas of a web page 201, 202, 203 and 204. The content in each area is the logo 205 in area 201, the horizontal block of text 206 in area 202, the vertical column of text 207 in area 203 and both the horizontal block of text 208 and the table of cars/prices 209 in area 204.

The standard tools typically prompt the author to produce a document (such as the one shown in FIG. 2) in which the content and the style are embedded in a single file defining the document. This makes it difficult to re-organise the layout without moving the content or change the content without reorganising the layout.

One development intended to simplify the process of authoring web content to be processed by a web server or web browser is to provide style sheets. A style sheet is a set of rules which can be applied to a document in order to control the style of presentation of the content of that document. They can either apply a style to a whole document or perhaps to just a part of the document. As such, they allow the author to separate the style from the content. A similar approach occurs for directly referring to images and sometimes content. In each case, the finished web page when rendered will appear the same.

By following aspects of the present invention to provide a method and a system for authoring web content which may provide the author with more flexibility in subsequent adaptation of the authored web content.

According to a first aspect the invention provides a method of authoring content to be served comprising:

authoring a layout document which defines at least one area of a document which includes the content to be published;

authoring at least one binding element which defines the identity and location of at least portion of content and at least one style description which defines a style to be applied to a selected portion of content;

in which the step of authoring the layout document includes allocating to the at least one defined area a director to at least one binding document of the or each binding element such that when processed the published document includes in the defined area the content as directed by the binding element in the style as directed by the binding element.

The content to be served may be, for example, processed by a web server for serving to clients.

By providing a binding element the content and the style description are separated from the layout document and are only referred to by the layout document indirectly. This is different from the prior art in which content and/or style are embedded within, or directly referred to, in the layout document. This allows the author greater flexibility should they subsequently wish to make changes to the layout, content and/or style.

The method may comprise at least one binding element which does not itself contain any style or content, only containing directors to style or content.

It will be readily understood that by “published document” we may mean a page of a web site or a part of a page or a collection of pages. The content may be suitable for rendering on one or more of a wide variety of devices such as PDAs, PCs, telephones etc. The content may comprise a web page, and may have active content such as forms, buttons, links etc.

The method may comprise providing content in the form of an electronic file which may contain a portion of text, or an image, or perhaps a combination of text and image content. The file may comprise a portion of code written for example in a mark-up language such as XML, XSL-FO or CSS. This may, for example, be produced using a text editor.

The method may comprise providing at least one style description which also comprises an electronic file such as a portion of code written for example in a mark-up language such as XML. Again this may be simply produced using a text editor.

The method may comprise defining at least one director provided in the layout document which may comprise an attribute, and each binding element may comprise an entity which may be allocated a unique label referenced by the attribute.

The layout document may further be authored to include in the at least one area a label or attribute indicating the type of content that is to be provided, such as a label to indicate that the content for that area is a header or an image.

More than one style description may be provided, and these may be as separate electronic files or as sub-portions of a single file. Where they are sub-portions the start and end of each sub-portion may be indicated by delimiting tags.

A single binding element may define the identity and location of more than one style description where more than one style description is provided. Similarly, it may define the identity and location of more than one portion of content. For example, if an area of the layout is to contain two paragraphs of text, each different and in a different style, a director to a single binding element indicating the identity and location of two portions of text (the two portions of content) and two style descriptions, may be provided. =p Two or more binding elements may direct to a common portion of content or style description. Sharing content and/or style descriptions in this way further simplifies the task of the author and makes it simple to make wide ranging changes to the content and/or style without having to edit the binding elements or the layout document.

More than one binding element may be provided, and the layout document may include a director to each binding element or perhaps to a subset of the total number of binding elements. It is envisaged, for example, that a number of binding elements may be defined which can be used across a number of authored web content documents. They may not all be required for every one of the documents.

It will be appreciated that the first aspect of the invention allows an author to author a document in such a manner that it is relatively straightforward to adapt the content for use on a range of devices. For example, the layout can easily be changed without a need to change the area references to the content, or the content can be changed simply by editing a binding element. Also, since style description and content are separated a change to the content can be made without needing to redefine its style or vice versa.

According to a second, different, aspect the invention provides a system for authoring content to be processed by a server comprising:

a layout document processor for producing a layout document which defines at least one area of a document which includes the content to be published;

binding element authoring means for defining at least one binding element which defines the identity and location of at least portion of content and at least one style description which defines a style to be applied to a selected portion of content, and in which the layout document processor is arranged to allocate to the at least one defined area a director to at least one binding document of the or each binding element such that when processed the published document includes in the defined area the content as directed by the binding element in the style as directed by the binding element.

According to a third aspect the invention provides a data structure that is suitable for processing by a server for rendering as a document, the data structure comprising:

a layout document which defines at least one area of a document which includes the content to be published;

at least one binding element which defines the identity and location of at least portion of content and at least one style description which defines a style to be applied to a selected portion of content;

in which the layout document includes at least one binding document of the or each binding element allocated to at least one of the areas such that when processed the published document includes in the defined area the content as directed by the binding element in the style as directed by the binding element.

The data structure may comprise one or more program files which each comprise a portion of code, which may be written in a mark-up language such as XML that can be processed by a web server. The files may be stored separately or may form a part of a single file.

The data structure may comprise one or more discrete sections of machine readable data, a first section defining the a layout document, a second section defining the at least one binding element and a third section defining content, and a fourth section defining at least one style description.

The discrete sections may form part of a single file of machine readable data or separate files of machine readable data.

Where the or each binding element comprises a separate file the or each director in the layout document may identify an associated binding element by its file name.

According to a fourth aspect, the invention provides a data structure that is suitable for programming a processor of a computing device to author servable conent, the programmed processor being adapted to: author a layout document which defines at least one area of a document which includes the content to be published; author at least one binding element which defines the identity and location of at least a portion of content and at least one style description which defines a style to be applied to a selected portion of content; in which authoring the layout document includes allocating to the at least one defined area a director to at least one binding document of the or each binding element such that when processed the published document includes in the defined area the content as directed by the binding element in the style as directed by the binding element.

There will now be described, by way of example only, one embodiment of the present invention with reference to the accompanying drawings of which:

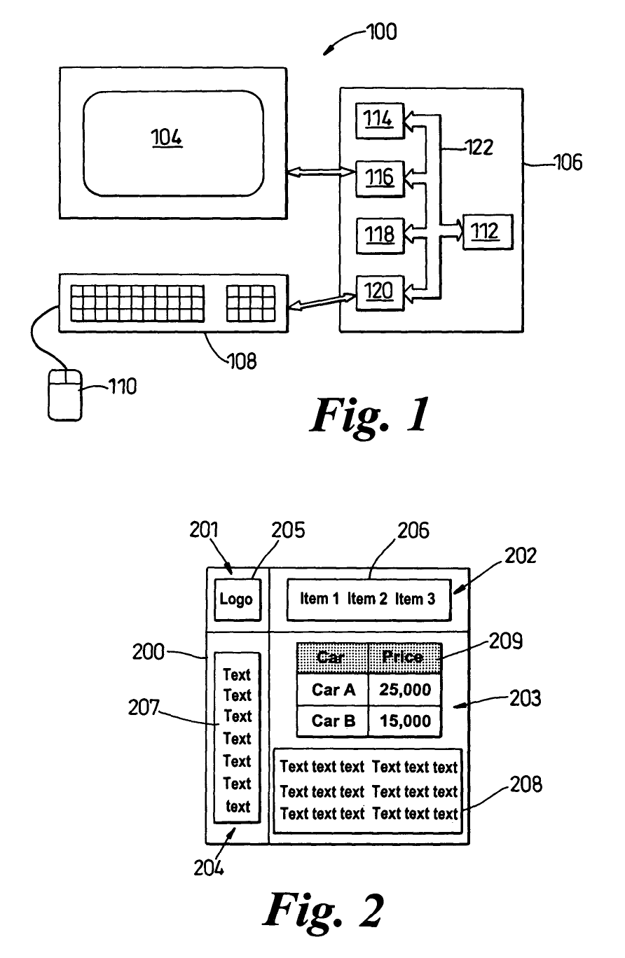

FIG. 1 schematically shows the architecture of a computer capable of acting as a server for this invention;

FIG. 2 is an example of a simple web page after it has been processed by a web browser and rendered on a display;

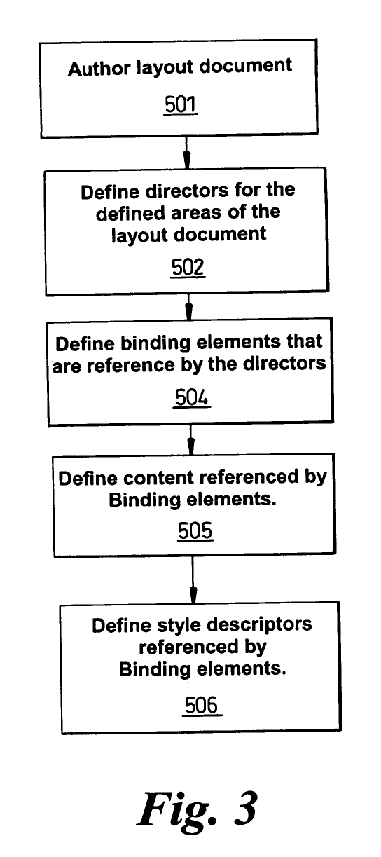

FIG. 3 is a flow chart of the steps performed in one example of a method in accordance with a first aspect of the invention; and

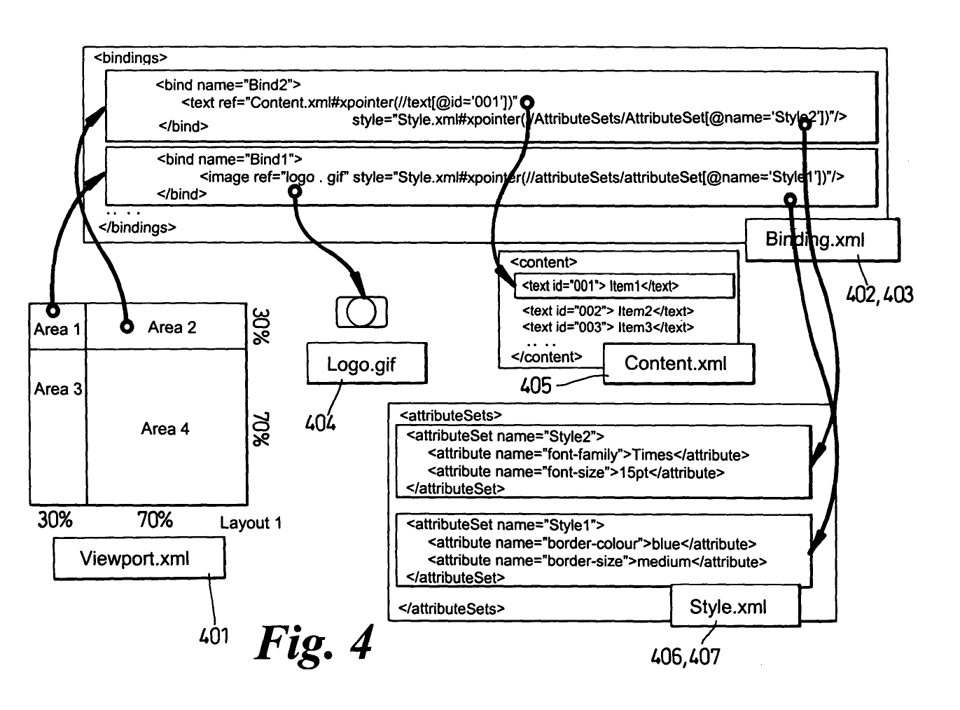

FIG. 4 is an overall representation of the directional relationships between a layout document, two portions of content and two style descriptions which are defined by a program in accordance with the third aspect of the present invention which may be rendered by a web browser to provide the web page of FIG. 2; and

This particular invention is applicable to distribute data electronically, and in particular web content via the World Wide Web, or in short the web. Such technology is well known. Generally the data to be distributed is held on a processing apparatus, or server 100, as shown in FIG. 1, and can be requested by any number of devices that are capable of communicating with the server 100.

In this embodiment the processing apparatus, or server 100, comprises a display 104, processing circuitry 106, a keyboard 108, and mouse 110. The processing circuitry 106 further comprises a processing unit 112, a hard drive 114, a video driver 116, memory 118 (RAM and ROM) and an I/O subsystem 120 which all communicate with one another, as is known in the art, via a system bus 122. The processing unit 112 comprises an INTEL™ PENTIUM™ series processor, running at typically between 2 GHz and 2.5 GHz.

As is known in the art the ROM portion of the memory 118 contains the Basic Input Output System (BIOS) that controls basic hardware functionality. The RAM portion of memory 118 is a volatile memory used to hold instructions that are being executed, such as program code, etc. The hard drive 114 is used as mass storage for programs and other data.

Other devices such as CDROMS, DVD ROMS, network cards, etc. could be coupled to the system bus 122 and allow for storage of data, communication with other computers over a network, etc.

The server 100 could have the architecture known as a PC, originally based on the IBM™ specification, but could equally have other architectures. The server may be an APPLE™, or may be a RISC system, and may run a variety of operating systems (perhaps HP-UX, LINUX, UNIX, MICROSOFT™ NT, AIX™, or the like).

In this embodiment web content, in this case a web-site, is held on the server 100.

FIG. 2 of the accompanying drawings shows a simple web page. The web page, when rendered, comprises four discrete areas of a web page 201, 202, 203 and 204. The content in each area is the logo 205 in area 201, the horizontal block of text 206 in area 202, the vertical column of text 207 in area 204 and both the horizontal block of text 208 and the table of cars/prices 209 in area 203.

The web page is therefore defined by some web content (the text, logo and table) produced by an author which is written in a language that can be read by a web browser or server. The web content is in essence a piece of machine readable data, or computer program, which defines structure data that can be processed by the browser. The browser has a set of rules which permit it to extract the data from the structure and determine both how the document is to appear and what it contains. Several languages have now been established for the writing of the structured data with the most popular being the Extensible Mark-up Language (XML) which forms the basis of the example described hereinafter.

In one embodiment of the present invention, an author performs several steps in order to produce a set of data structured according to a set of rules as a computer program which may be rendered to produce the document of FIG. 2 of the accompanying drawings. In these steps the author produces the following sections of data structure:

A layout document 401;

At least one binding element 402,403

At least one portion of content 404,405; and

A least one style description 406,407.

The authoring of each section may be performed in any order so that the author can provide the layout document 401 before the content 404,405 or vice versa. However, all the sections must be produced before they can be passed as a whole to a web server for processing. FIG. 3 of the accompanying drawings is a flow chart setting out, by way of example only, a typical set of steps which are to be performed in accordance with one embodiment of the invention to produce the simple web page of FIG. 2.

In a first step the author decides on the layout of the page whereafter a layout document 401 is produced 501 which formalises the chosen layout using rules defined by a language that can be understood by the browser.

The layout document 401 defines the overall layout of the web page. As shown in FIG. 2 the web page can be considered to comprise four areas-labelled Area 1, Area 2, Area 3 and Area 4, referenced by numerals 201,202,203 and 204 respectively in FIGS. 2 and 3(a). This layout document of the example is a program file written in the XML programming language and is named “viewport.xml”. Of course, other languages could be used.

In a next step 502, the author defines, for each area in the layout document, a director which directs a browser processing the XML portion to a binding element.

An example of a suitable layout document, written in XML for use in producing the web page of FIG. 2 is:

XML Layout Description

<viewport>

<layout name=“main-results”>

<grid rows=“2” columns=“2”>

<row name=“header”>

<cell ref=“//areas/area[name=‘Area1’]”/>
<cell ref=“//areas/area[name=‘Area2’]”/>

</row>
<row name=“content”>

<cell ref=“//areas/area[name=‘Area3’]”/>
<cell ref=“//areas/area[name=‘Area4’]”/>

</row>

</grid>

</layout>
<areas>

<area name=“Area1” width=“30%” height=“30%”>

<image>

<content
ref=“binding.xml#xpointer(//bindings/bind[@name=‘Bind1’])”/>

</image>

</area>
<area name=“Area2” width=“70%” height=“30%”>

<menu>

<menu-item>

<content
ref=“binding.xml#xpointer(//bindings/bind[@name=‘Bind2’])”>

</menu-item>
. . .

</menu>

</area>
. . .

</areas>

</viewport>

After defining a layout document 401, an author may in a next step 503 define all the binding elements 402,403 that are referred to by the directors in the layout document. As shown in FIG. 4 a single XML file may be authored which contains a number of sections that each define a binding element. Each director references at least one of these sections, such as “bind1” for area 1, “bind 2” for area 2 and so on. The XML file defining the binding elements 402,403 is named “binding.XML” and so in this example embedded within each area 201,202,203,204 of the layout document is a director of the form “binding.xml, bind n” where n is the number of the appropriate sub portion of the file.

Also as shown in FIG. 4, each section of the binding file, i.e. each binding element, is embedded with a director to a portion of content and a style description. FIG. 4 only shows the content and style directors for Areas 1 and 2 for simplicity. The skilled man will readily understand from this what files would be needed to complete the remaining two areas of the rendered document.

A suitable file written in XML language for the bindings may be as follows:

```
<bind name=“Bind2”>
  <text ref=“Content.Xml#pointer(//text[@id=‘001’])”
    style=“Style.xml#pointer(//Attributesets/AttributeSet[@name=‘Style2’])”/>
</bind>
<bind name=“Bind1”>
  <image ref=“logo.gif” style=” Style.xml#pointer
(//Attributesets/AttributeSet[@name=‘Style2’])”/>
</bind>
```

Having authored the layout description and the binding elements, the author next may author 505 the required content 405,406 followed in a final step 506 by authoring the required style descriptions.

In this example, the content for Area 1 is a logo image 404 authored as a .gif image file called “logo.gif”. Binding 1 refers to the name of this file. Similarly, the content for Area 2 is a portion of text which is written into a short file in XML language called “content.xml”. Binding 1 refers to the name of this file.

A file called “Style.xml” is also provided which contains two style descriptors 406,407 called “style 1” and “style 2”. Style 1 is a portion of XML code which defines the style to be applied to the logo in area 1, whilst Style 2 defines the style to be applied to the text on Area 2. Each of the bindings includes the name of the style descriptor to be applied to the content.

The Style.xml file may in this example have the form:

```
<attributeSets>
<AttributeSet name= “Style 2”>
    <attribute name=“font-family”>Times<attribute>
    <attribute name=“font-size”>15pt</attribute>
</attributeSet>
<AttributeSet name= “Style 1 ”>
    <attribute name=“border-colour”>blue<attribute>
    <attribute name=“border-size”>medium</attribute>
    </attributeset>
</attributeSets>
```

It will therefore be seen that the layout document 401 does not directly refer to any specific content or style to be applied to that content. Indeed the identity and location of both the content and the style is completely unknown to the layout document. It is the binding elements 402,403 that direct the browser or server to the required content and style. This arrangement provides for a flexible method of authoring web content which provides for great flexibility in subsequent alteration to the web content.

When a requesting device such as a web server or browser requests the document the layout document is sent to the browser. In the process of reading this file the browser is instructed to add the content and style indicated by the directors to the binding elements.

Many permutations of the method of the example may be made whilst remaining within the scope of the present invention. For example, the order in which the steps are performed can be varied. Layout documents, style descriptions, bindings and content may be authored ab initio, or pre-authored existing examples may be used where this is possible. For example, an existing portion of content such as a logo may be referenced by a newly authored binding element. Also, whilst the example given relates to a simple web page it will be appreciated that the method of the invention is applicable to a variety of types of document which may be hosted on a variety of types of device.

1. A method of authoring content to be served comprising:
authoring a layout document which defines at least one area of a document which includes the content to be published;
authoring at least one binding element which defines the identity and location of at least a portion of content and at least one style description which defines a style to be applied to a selected portion of content;
in which the step of authoring the layout document includes allocating to the at least one defined area a director to at least one binding document of the or each binding element such that when processed the published document includes in the defined area the content as directed by the binding element in the style as directed by the binding element.

2. The method of claim 1 in which the binding element does not itself contain any style or content, only containing directors to style or content.

3. The method of claim 1 or claim 2 in which the content is provided as an electronic file which contains a portion of text, or an image, or a combination of text and image content.

4. The method of claim 3 in which the file comprises a section of data written for example in a mark-up language such as XML.

5. The method of any preceding claim in which the style description is provided in the form of an electronic file written for example in a mark-up language such as XML.

6. The method of any preceding claim in which the director to a binding element provided in the layout document is defined as an attribute within a section of machine readable data written in a mark-up language.

7. The method of any preceding claim in which more than one style description is provided,

8. The method of any preceding claim which comprises defining a binding element which defines the identity and location of more than one style description or the identity and location of more than one portion of content.

9. The method of any preceding claim comprising the step of defining two or more binding elements which direct to a common portion of content or style description.

10. The method of any preceding claim in which more than one binding element is provided, and the layout document includes a director to some or all of the total number of binding elements.

10. A system for authoring content to be served comprising:
a layout document processor for producing a layout document which defines at least one area of a document which includes the content to be published;
binding element authoring means for defining at least one binding element which defines the identity and location of at least portion of content and at least one style description which defines a style to be applied to a selected portion of content, and in which the layout document processor is arranged to allocate to the at least one defined area a director to at least one binding document of the or each binding element such that when processed the published document includes in the defined area the content as directed by the binding element in the style as directed by the binding element.

11. A data structure that is suitable for processing by a server for serving as a document, the data structure comprising:
a layout document which defines at least one area of a document which includes the content to be published;
at least one binding element which defines the identity and location of at least portion of content and at least one style description which defines a style to be applied to a selected portion of content;
in which the layout document includes at least one binding element of the or each binding element allocated to at least one of the areas such that when processed the published document includes in the defined area the content as directed by the binding element in the style as directed by the binding element.

12. The data structure of claim 11 which comprises one or more discrete sections of machine readable data, a first section defining the a layout document, a second section defining the at least one binding element and a third section defining content, and a fourth section defining at least one style description.

13. The data structure of claim 12 in which the discrete sections form part of a single file of machine readable data or separate files of machine readable data.

14. A data structure that is suitable for programming a processor of a computing device to author servable conent, the programmed processor being adapted to:
author a layout document which defines at least one area of a document which includes the content to be published;
author at least one binding element which defines the identity and location of at least a portion of content and at least one style description which defines a style to be applied to a selected portion of content;
in which authoring the layout document includes allocating to the at least one defined area a director to at least one binding document of the or each binding element such that when processed the published document includes in the defined area the content as directed by the binding element in the style as directed by the binding element.

15. A method of authoring content to be processed by a server substantially as described herein with reference to and as illustrated in the accompanying drawings.

16. A system for authoring content to be processed by a server substantially as described herein with reference to and as illustrated in the accompanying drawings.

17. A data structure that is suitable for processing by a server for rendering as a document substantially as described herein with reference to and as illustrated in the accompanying drawings.
